(19) United States
(12) Patent Application Publication
(10) Pub. No.: US 2025/0285428 A1
(43) Pub. Date: Sep. 11, 2025

(54) INTELLIGENT INDUSTRIAL WORKSHOP INSPECTION BASED ON ARTIFICIAL INTELLIGENCE

(71) Applicant: International Business Machines Corporation, Armonk, NY (US)

(72) Inventors: Yuan Yuan Ding, Shanghai (CN); Zhong Fang Yuan, Xi'an (CN); Li Juan Gao, Xi'an (CN); Tong Liu, XI'AN (CN)

(21) Appl. No.: 18/599,064

(22) Filed: Mar. 7, 2024

(51) Int. Cl. G06V 10/86; G06F 40/40; G06Q 50/26; G06V 10/26; G06V 10/82; G06V 20/40; G06V 20/52

(52) U.S. Cl. CPC G06V 10/86; G06F 40/40; G06Q 50/265; G06V 10/273; G06V 10/82; G06V 20/41; G06V 20/52

(57) ABSTRACT

An example operation may include one or more of storing a safety specification for an industrial equipment and a video of an operation that is performed with the industrial equipment, identifying a plurality of video frames within the video that are associated with the operation that is performed with the industrial equipment, generating a description of the plurality of video frames based on execution of a multi-modal artificial intelligence (AI) model on the plurality of video frames, determining a safety issue with respect to the operation that is performed based on execution of a language machine learning model on the description of the plurality of video frames and text content from the safety specification, and displaying an identifier of the safety issue on a display screen associated with the industrial equipment.

### BACKGROUND

In the industrial field, workshop inspection and equipment quality maintenance are critical processes to ensure the safe operation of production lines, and product quality. Many workshops use cameras to record videos of users interacting with the equipment during operations within the workshop.

### SUMMARY

One example embodiment provides a computer-implemented method that includes one or more of identifying a plurality of video frames within a video of an operation that is performed with industrial equipment, generating a description of the plurality of video frames based on execution of an artificial intelligence (AI) model on the plurality of video frames, determining a safety issue with respect to the operation based on execution of a language machine learning model on the description of the plurality of video frames and text from a safety specification for the industrial equipment, and presenting an identifier of the safety issue via a computer output device associated with the industrial equipment.

Another example embodiment provides a computer system that may include a processor set, a set of one or more computer-readable storage media, and program instructions, collectively stored in the set of one or more storage media, for causing the processor set to perform computer operations to one or more of identify a plurality of video frames within a video of an operation that is performed with industrial equipment, generate a description of the plurality of video frames based on execution of an artificial intelligence (AI) model on the plurality of video frames, determine a safety issue with respect to the operation based on execution of a language machine learning model on the description of the plurality of video frames and text from a safety specification for the industrial equipment, and present an identifier of the safety issue via an output device of a computer associated with the industrial equipment.

A further example embodiment provides a computer program product that may include a set of one or more computer-readable storage media, and program instructions, collectively stored in the set of one or more computer-readable storage media, for causing a processor set to perform computer operations including one or more of identifying a plurality of video frames within a video of an operation that is performed with industrial equipment, generating a description of the plurality of video frames based on execution of an artificial intelligence (AI) model on the plurality of video frames, determining a safety issue with respect to the operation based on execution of a language machine learning model on the description of the plurality of video frames and text from a safety specification for the industrial equipment, and displaying an identifier of the safety issue on a display screen associated with the industrial equipment.

### BRIEF DESCRIPTION OF THE DRAWINGS

FIG. 1 is a diagram illustrating a computing environment according to an embodiment of the instant solution.

FIG. 2 is a diagram illustrating a workshop inspection system for inspecting operations with industrial equipment according to an embodiment of the instant solution.

FIG. 3A is a diagram illustrating a process of a neural network which determines a correlation between a description of a task and video frames according to example embodiments.

FIG. 3B is a diagram illustrating a process of a segmentation network masking a subset of the video frames based on an object of interest according to example embodiments.

FIG. 3C is a diagram illustrating a process of generating descriptions of content that remains in a masked video frame according to example embodiments.

FIG. 3D is a diagram illustrating a process of a knowledge mapping model generating a knowledge graph based on text content included in a safety specification according to example embodiments.

FIG. 3E is a diagram illustrating a process of a large-language model (LLM) detecting a potential safety issue within video content according to example embodiments.

FIG. 4A illustrates a flow diagram, according to example embodiments.

FIG. 4B illustrates a flow diagram, according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided an apparatus that includes a memory and a processor coupled to the memory. The processor is configured to store a safety specification for an industrial equipment and a video of an operation that is performed with the industrial equipment. The processor is configured to identify a plurality of video frames within the video that are associated with the operation that is performed with the industrial equipment. The processor is configured to generate a description of the plurality of video frames based on execution of a multi-modal artificial intelligence (AI) model on the plurality of video frames. The processor is configured to determine a safety issue with respect to the operation based on execution of a language machine learning model on the description of the plurality of video frames and text content from the safety specification. One example of a language machine learning model is a large language model (LLM). The processor is configured to display an identifier of the safety issue on a display screen associated with the industrial equipment. The apparatus has the technical effect of detecting a safety issue from video content of an industrial environment. A technical advantage of the apparatus is that the safety issue can be detected in real-time, and in an automated manner.

In embodiments, the processor is further configured to receive a description of the operation that is performed and select a subset of video frames that show the operation that is performed from a set of video frames included in the video based on execution of a neural network on the set of video frames and the description of the operation that is performed. The technical effect of this feature is that text input can be used to further reduce the video content used for analysis. The technical advantage of this feature is that the processing is only performed on some of the video frames, not all, resulting in faster processing time in comparison to analyzing all video frames.

In some embodiments, the processor is further configured to generate a confidence value for a respective video frame among the set of video frames based on the execution of the neural network and include the respective video frame in the subset of video frames when the confidence value is above a predetermined threshold. The technical advantage of this feature is that the apparatus ensures high confidence that the video frames being used are related to the industrial operation.

In some embodiments, the processor is further configured to mask content within the plurality of video frames to remove unrelated content which is unrelated to the industrial equipment based on execution of a segmentation model, prior to the execution of the multi-modal AI model on the plurality of video frames. The technical advantage of this feature is that unrelated content can be removed from the image analysis thereby enabling a more accurate analysis of the content associated with the industrial operation.

In some embodiments, the processor is further configured to mask the plurality of video frames based on a description of an object of interest which is input into the segmentation model. The technical effect of this feature is that text input can be used to mask unrelated content within a video frame of interest. The technical advantage of this feature is that unrelated content can be removed from the image analysis thereby enabling a more accurate analysis of the content associated with the industrial equipment.

In some embodiments, the processor is further configured to generate a knowledge graph based on text content included in the safety specification, wherein the knowledge graph comprises nodes representing pieces of equipment, and edges between the nodes represent operational dependencies between the pieces of equipment. The technical effect of this feature is that text content from a descriptive manual, such as document, can be embodied in a graph.

In some embodiments, the processor is further configured to determine the safety issue with respect to the operation that is performed based on execution of the language machine learning model (for example, an LLM) on the knowledge graph. The technical advantage of this feature is using known safety standards to perform the image analysis for safety issues of the industrial environment in an automated manner.

According to an aspect of the example embodiments, there is provided a method that includes storing a safety specification for an industrial equipment and a video of an operation that is performed with the industrial equipment. The method also includes identifying a plurality of video frames within the video that are associated with the operation that is performed with the industrial equipment. The method also includes generating a description of the plurality of video frames based on execution of a multi-modal artificial intelligence (AI) model on the plurality of video frames. The method also includes determining a safety issue with respect to the operation that is performed based on execution of a language machine learning model on the description of the plurality of video frames and text content from the safety specification. The method also includes displaying an identifier of the safety issue on a display screen associated with the industrial equipment. The method has the technical effect of detecting a safety issue from video content of an industrial environment. A technical advantage of the method is that the safety issue can be detected in real-time, and in an automated manner.

In some embodiments, the method includes receiving a description of the operation that is performed, and the identifying comprises selecting a subset of video frames that show the industrial equipment from a set of video frames included in the video based on execution of a neural network on the set of video frames and the description of the operation that is performed. The technical effect of this feature is that text input can be used to further reduce the video content used for analysis. The technical advantage of this feature is that the processing is only performed on some of the video frames, not all, resulting in a faster processing time in comparison to analyzing all video frames.

In some embodiments, the method includes generating a confidence value for a respective video frame among the set of video frames based on the execution of the neural network and including the respective video frame in the subset of video frames when the confidence value is above a predetermined threshold. The technical advantage of this feature is that the method ensures high confidence that the video frames being used are related to the industrial operation.

In some embodiments, the method includes masking content within the plurality of video frames to remove unrelated content which is unrelated to the industrial equipment based on execution of a segmentation model, prior to the execution of the multi-modal AI model on the plurality of video frames. The technical effect of this feature is that text input can be used to mask unrelated content within a video frame of interest. The technical advantage of this feature is that unrelated content can be removed from the image analysis thereby enabling a more accurate analysis of the content associated with the industrial equipment.

In some embodiments, the masking content includes masking the plurality of video frames based on a description of an object of interest within the video which is input into the segmentation model. The technical advantage of this feature is that unrelated content can be removed from the image analysis thereby enabling a more accurate analysis of the content associated with the industrial equipment.

In some embodiments, the method includes generating a knowledge graph based on text content included in the safety specification, wherein the knowledge graph comprises nodes representing pieces of equipment, and edges between the nodes represent operational dependencies between the pieces of equipment. The technical effect of this feature is that text content from a descriptive manual, such as document, can be embodied in a graph.

In some embodiments, the determining the safety issue with respect to the operation that is performed is based on execution of the a language machine learning model on the knowledge graph. The technical advantage of this feature is using known safety standards to perform the image analysis for safety issues of the industrial environment in an automated manner.

According to an aspect of the example embodiments, there is provided a computer-readable storage medium that includes instructions stored therein which when executed by a processor cause the processor to perform storing a safety specification for an industrial equipment and a video of an operation that is performed with the industrial equipment. The instructions further cause the processor to perform identifying a plurality of video frames within the video that are associated with the operation that is performed with the industrial equipment. The instructions further cause the processor to perform generating a description of the plurality of video frames based on execution of a multi-modal artificial intelligence (AI) model on the plurality of video frames. The instructions further cause the processor to perform determining a safety issue with respect to the operation that is performed based on execution of a language machine learning model on the description of the plurality of video frames and text content from the safety specification. The instructions further cause the processor to perform displaying an identifier of the safety issue on a display screen associated with the industrial equipment. The medium has the technical effect of detecting a safety issue from video content of an industrial environment. A technical advantage of the medium is that the safety issue can be detected in real-time, and in an automated manner.

In some embodiments, the instructions further cause the processor to perform receiving a description of the operation that is performed, and the identifying comprises selecting a subset of video frames that show the industrial equipment from a set of video frames included in the video based on execution of a neural network on the set of video frames and the description of the operation that is performed. The technical effect of this feature is that text input can be used to further reduce the video content used for analysis. The technical advantage of this feature is that the processing is only performed on some of the video frames, not all, resulting in a faster processing time in comparison to analyzing all video frames.

In some embodiments, the instructions further cause the processor to perform generating a confidence value for a respective video frame among the set of video frames based on the execution of the neural network and including the respective video frame in the subset of video frames when the confidence value is above a predetermined threshold. The technical advantage of this feature is that the processor ensures high confidence that the video frames being used are related to the industrial operation.

In some embodiments, the instructions further cause the processor to perform masking content within the plurality of video frames to remove unrelated content which is unrelated to the industrial equipment based on execution of a segmentation model, prior to the execution of the multi-modal AI model on the plurality of video frames. The technical advantage of this feature is that unrelated content can be removed from the image analysis thereby enabling a more accurate analysis of the content associated with the industrial operation.

In some embodiments, the instructions further cause the processor to perform masking the plurality of video frames based on a description of an object of interest within the video which is input into the segmentation model. The technical effect of this feature is that text content from a descriptive manual, such as document, can be embodied in a graph.

In some embodiments, the instructions further cause the processor to perform generating a knowledge graph based on text content included in the safety specification, wherein the knowledge graph comprises nodes representing pieces of equipment, and edges between the nodes represent operational dependencies between the pieces of equipment. Furthermore, the safety issue can be determined with respect to the operation that is performed is based on execution of the language machine learning model on the knowledge graph. The technical effect of this feature is that text content from a descriptive manual, such as document, can be embodied in a graph and used to identify the safety issue from the video content.

The example embodiments are directed to a comprehensive artificial intelligence (AI) system capable of inspecting large amounts of video collected from an industrial workshop including operations with equipment included in the industrial workshop. The system can detect potential safety issues and other concerns that can create danger and deteriorate the equipment within the workshop using an artificial intelligence (AI) system. The issues can create unsafe conditions for people in the workshop, damage the equipment within the workshop, and the like. The benefits of this system include the ability to analyze vast amounts of workshop inspection and equipment maintenance video data, identify problems, and resolve them quickly thereby preventing unsafe conditions within the workshop, poor quality with the products that are generated in the workshop, and the like. In some embodiments, the system may be hosted by a cloud computing environment.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

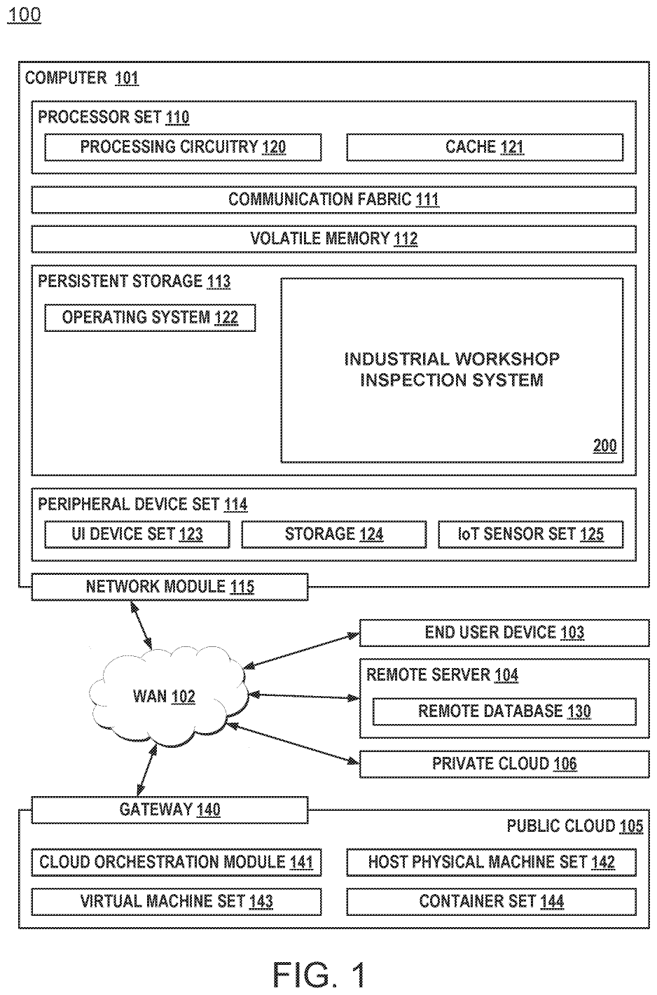

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as an industrial workshop inspection system 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

In the industrial field, workshop inspection and equipment quality maintenance are crucial processes to ensure the normal operation of production lines and product quality. However, traditional inspection and maintenance methods often suffer from issues such as time-consuming manual operations, reliance on human expertise, and the potential for oversights. Hence, there is a need to find an efficient, accurate, and automated solution.

In recent years, video-based technologies for workshop inspection and equipment quality maintenance have emerged as promising solutions. These technologies utilize cameras to record real-time videos in factory workshops and employ image processing and pattern recognition techniques to analyze the video data, enabling automated inspection and maintenance. However, due to the complexity of workshop environments and the diversity of equipment types, existing video-based inspection and maintenance technologies still have some limitations. For instance, they may lack adaptability to complex scenarios and exhibit poor generality across different types of equipment.

Furthermore, traditional video-based image analysis techniques often rely heavily on a large number of training images. In industrial scenarios, collecting effective images is a challenge, leading to data imbalance and poor model transferability. Consequently, it becomes difficult to meet the demands of constantly changing industrial settings, limiting the applicability of such technologies.

The example embodiments are directed to an artificial intelligence (AI) system that addresses these drawbacks. The system can analyze large amounts of video data from an industrial site and inspect the operations that are being performed with industrial equipment at the site. Through this process, the system can identify potential issues through improper maintenance, improper interaction with the industrial equipment, lack of quality, and the like.

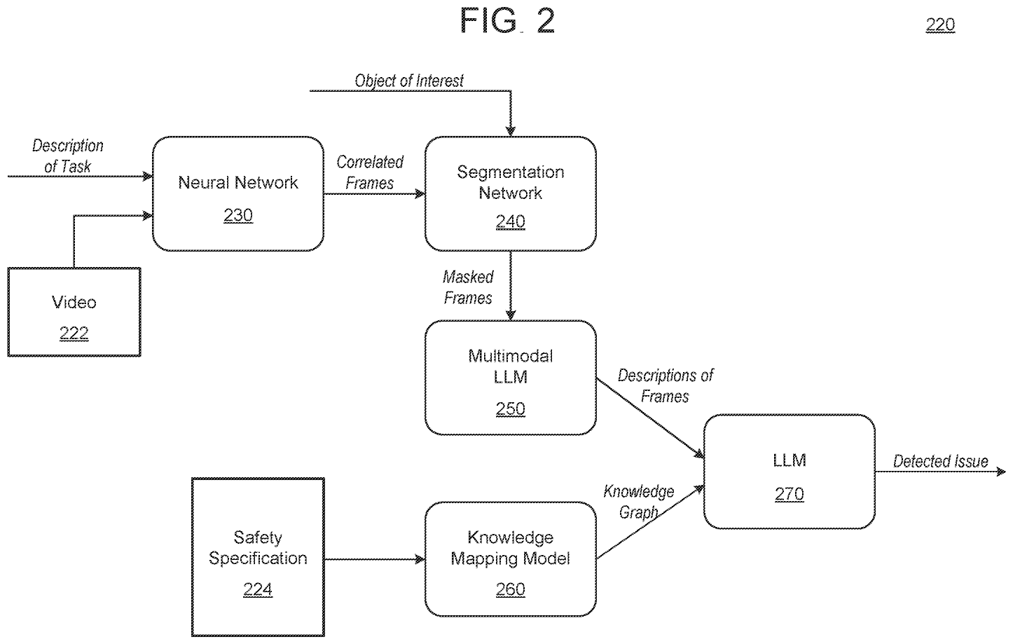

FIG. 2 illustrates a workshop inspection system 220 for inspecting operations with industrial equipment according to an embodiment of the instant solution. Referring to FIG. 2, the workshop inspection system 220 includes a neural network 230, a segmentation network 240, a multi-modal large-language model (LLM), a knowledge mapping model 260, and a LLM 270, which analyze a video file 222 of an industrial operation performed with industrial equipment for potential issues that can affect the safety of the people and the equipment involved, affect the quality of the operation, and the like. In one embodiment an LLM in an example of a language machine learning model. The workshop inspection system 220 may be hosted by a platform such as a cloud platform, a web server, a distributed system, and the like.

In this example, the neural network 230 refers to a machine learning model that makes decisions in a manner similar to a human brain, by using processes that mimic the way biological neurons work together to identify phenomena, weigh options, and arrive at conclusions. According to various embodiments, the neural network 230 may receive the video file 222 which includes images of an industrial operation performed with industrial equipment and a description (e.g., text content) of the operation being performed on industrial equipment which is shown in the video file 222. As an example, the operation may include a maintenance operation to repair a gasket on a piece of equipment such as a boiler. Here, the video may show a person performing the maintenance operation on the boiler. The description of the operation may recite that the operation is of a person performing a maintenance operation to fix a loose gasket on the boiler. Bot the video and the description may be input the neural network 230.

As an example, the neural network 230 may be a contrastive language-image pretraining (CLIP) model or the like which is trained on a variety of text and image pairs. Prior to the video file 222 being input to the neural network 230, the video file may be separated into individual frames. The neural network 230 may receive the video frames and the description of the operation being performed and determine a likelihood that a video frame includes the operation being performed. The likelihood may be output as a percentage or other value. The value may be compared to a predetermined threshold. If the percentage is above the predetermined threshold, the video frame may be determined as showing the operation.

A correlation process performed by the neural network 230 may be used to remove unrelated video frames from further consideration. The neural network 230 enables semantic relevance analysis between video content and tasks, facilitating rapid identification of video segments related to inspection tasks. To enhance the accuracy and efficiency of the video analysis, the remaining video frames may be input to the segmentation network 240 along with a description of an object of interest. For example, the segmentation network 240 may be a convolutional neural network (CNN), a recurrent neural network (RNN), or other type of deep learning model that is capable of processing visual data, extracting features and learning complex patterns from images.

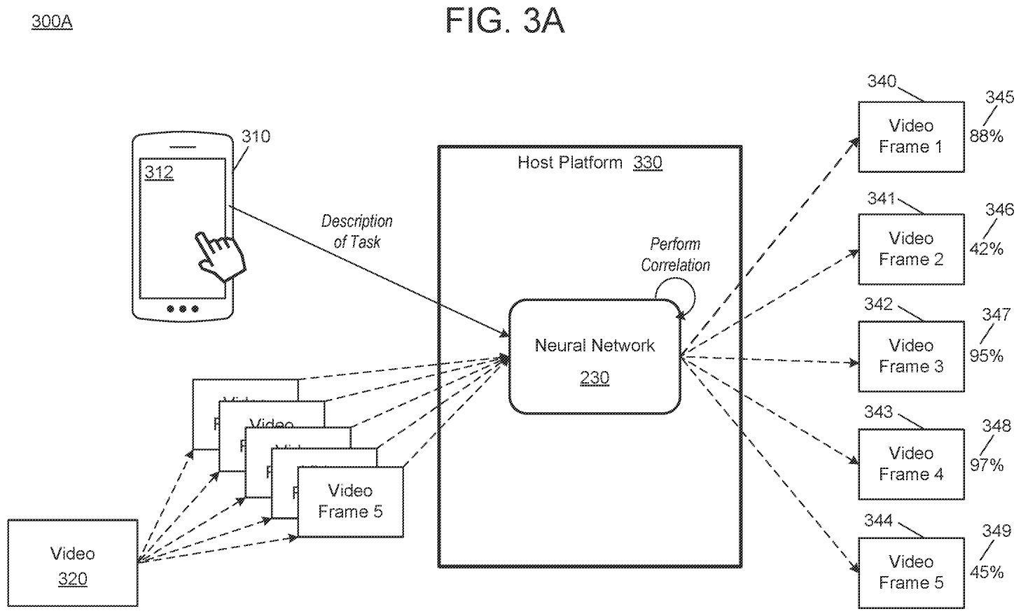

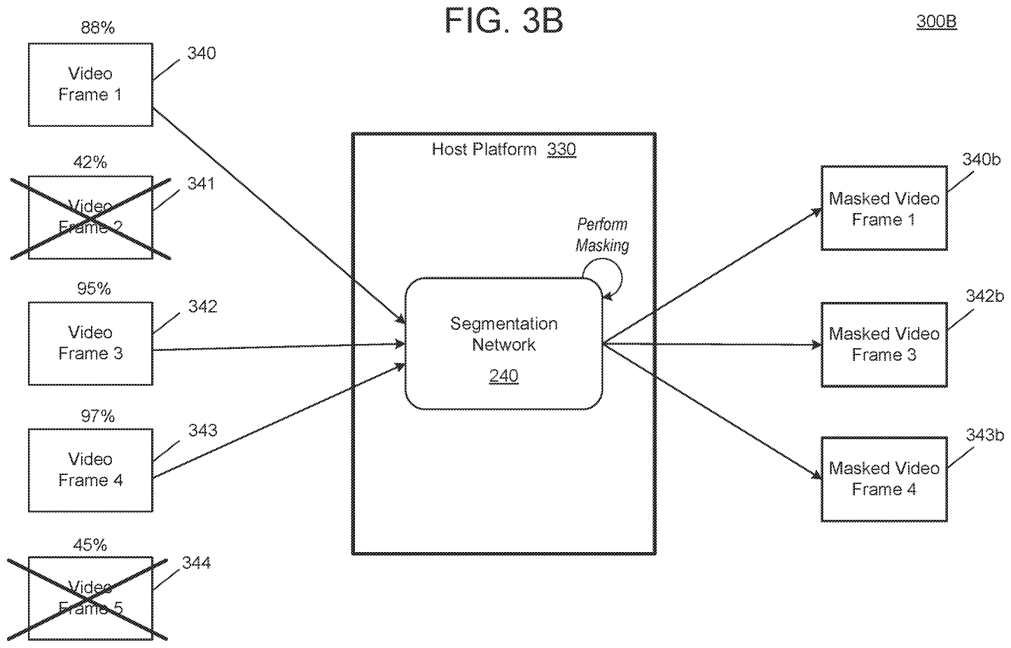

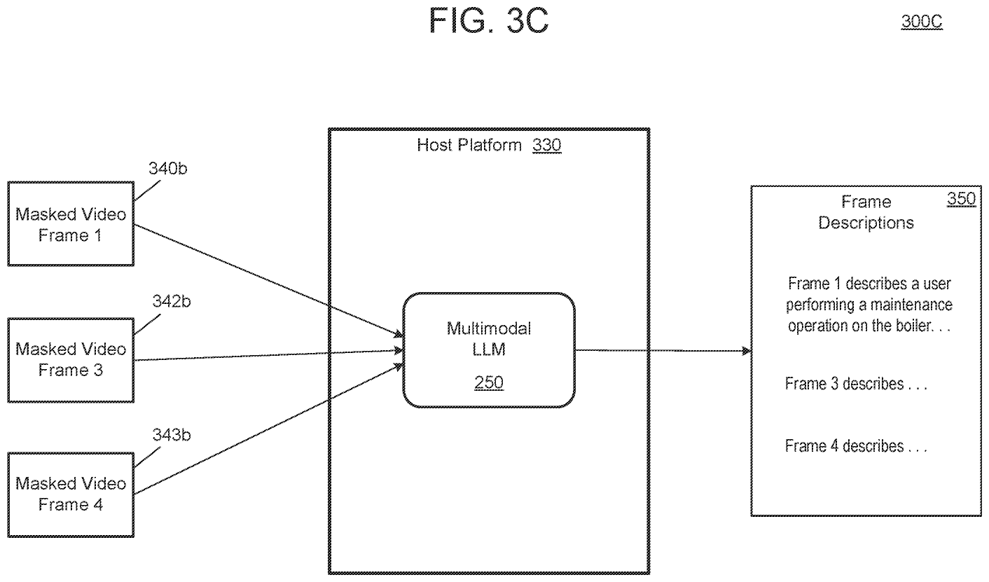

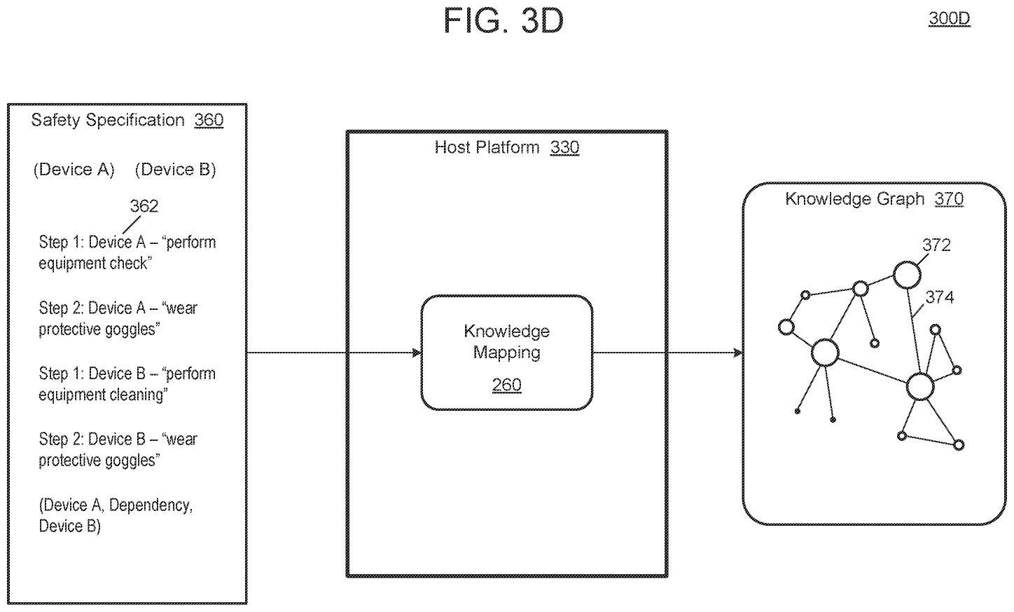

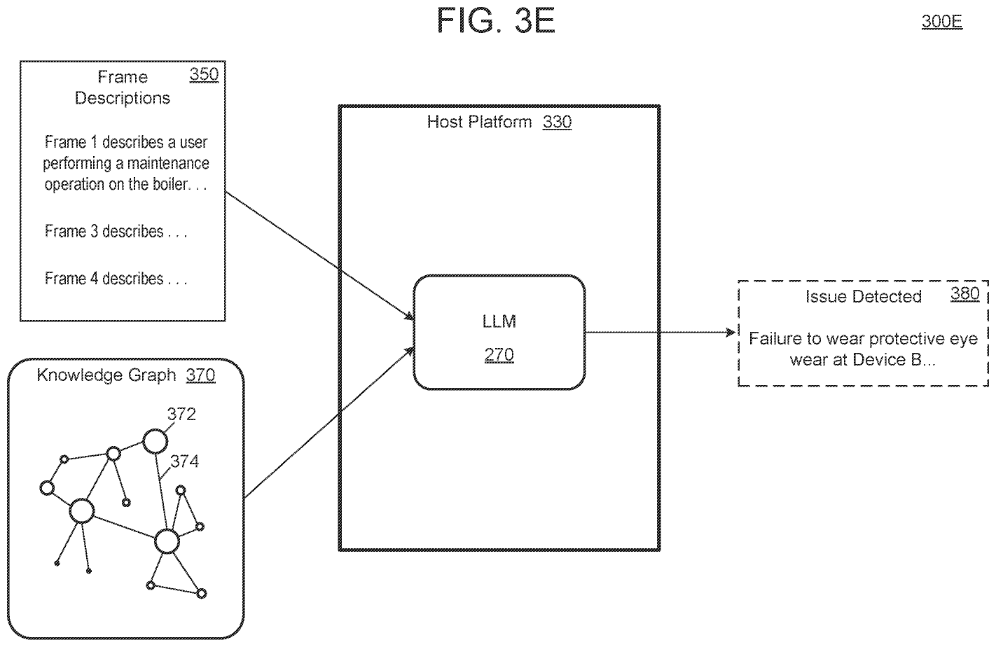

As an example, the object of interest may be the industrial equipment. Here, the description input to the segmentation network 240 may include a text-based description input from a user device such as a user device 310 shown in FIG. 3A. The user input may include a description of the object input via a user interface 312 of the user device 310 which is then input as a prompt to the segmentation network 240. As an example, the prompt may include a description of the object of interest (e.g., “workshop inspection equipment”, etc.) The segmentation network 240 can mask unrelated objects out of the image leaving only key objects in the video, such as the workshop inspection equipment or the like. That is, the segmentation network 240 may filter out irrelevant content for inspection. This approach allows for more precise identification of task-related targets and reduces the time and computational resources needed for analysis.

The masked frames may be input to the multimodal LLM 250. The multimodal LLM 250 may be trained to understand correlations between different types of data. For example, the multimodal model may be trained to understand a correlation between images and text using a multi-modal architecture. The multimodal LLM 250 may combine natural language processing (NLP) with image analysis. In response to receiving the masked frames, the multimodal LLM 250 may generate a text description of the content included in the masked frames. The multimodal LLM 250 may be referred to as an image captioning network which can analyze the content of the video frames and generate textual descriptions of the frame content, providing a more comprehensive understanding of the operations and events occurring in the video.

Meanwhile, a safety specification 224 (e.g., a safety manual, etc.) which includes a description of safe practices with the industrial equipment may be input to a knowledge mapping model 260. As an example, the knowledge mapping model 260 may be a graph neural network or other machine learning model that is capable of producing knowledge graph embeddings including nodes (e.g., workshop equipment devices, etc.) and edges (e.g., relationships between the devices, etc.). The knowledge mapping model 260 may generate a safety operation knowledge graph, including information about workshop safety operation specifications and equipment operating steps. For example, the output of the knowledge mapping model 260 may be a graph covering all operations performed by the respective devices included in the equipment, and dependencies between the operations performed by the devices. By analyzing and extracting triplets from the safety specification 224, the knowledge mapping model 260 may build a comprehensive knowledge graph related to safety operations. The knowledge graph may include relationships between pieces of equipment, operations that are performed with each piece of equipment, an order in which the operations are to be performed, and the like. Linking the results of video analysis to this knowledge graph enhances an understanding of the relationships between workshop operation specifications and potential connections between video targets. For instance, the system can detect if a worker's consecutive actions comply with regulations or whether a series of machine operations adhere to prescribed requirements. The knowledge graph may be built in advance of one or more instances of using the workshop inspection system 220 to detect and present safety issues.

Next, the safety operation knowledge graph output by the knowledge mapping model 260 and the descriptions of the video frames output by the multi-modal LLM 250 may be input to the LLM 270. The LLM 270 may be a large-scale language model (LLM) that may perform in-depth analysis on the preprocessed text to identify issues that have occurred during the operation, for example, a missed task, an improperly performed task, a missing part, and the like.

Through the system described in FIG. 2, vast amounts of workshop inspection data and equipment maintenance video data can be analyzed to identify problems, and resolve them promptly. Leveraging a deep understanding of the correlation between video content and tasks, combined with the safety operation knowledge graph and image analysis results, the system can provide comprehensive safety operation support and decision-making assistance for industrial workshops.

FIGS. 3A-3E are diagrams illustrating a process of inspecting video data of an industrial operation for safety issues according to embodiments of the instant solution. For example, FIG. 3A illustrates a process 300A of the neural network 230, hosted by a host platform 330, which determines a correlation between a description of an operation input by a user device 310 and vide frames from a video 320. Here, a user may input a description of the task/operation performed with the industrial equipment via a user interface 312 of the user device 310. Meanwhile, the video file 320 may be converted into a plurality of video frames that are input to the neural network 230 with the description. In response, the neural network 230 may output a confidence value indicating a likelihood of a respective video frame including the operation performed with the industrial equipment. The neural network 230 may identify the semantic relevance between the image content in the video frame and the text description. In at least some embodiments, the neural network 230 is trained beforehand with training data to learn how to correlate images to text.

In this example, the neural network 230 outputs confidence values 345, 346, 347, 348, and 349 that provide a likelihood of a plurality of video frames 340, 341, 342, 343, and 344 including/showing the operation with the industrial equipment. This may include images showing a user working with the equipment, and the like. FIG. 3B illustrates a process 300B of the segmentation network 240 masking a subset of the video frames based on an object of interest. In this example, the confidence values of the plurality of video frames 340, 341, 342, 343, and 344 may be compared to a predefined threshold. The threshold may be used to remove unrelated video frames from further analysis. In this example, the predefined threshold is 60%. Here, the video frame 341 and the video frame 344 include confidence values that are below the predetermined threshold. Here, the system may remove the video frame 341 and the video frame 344 from further analysis.

The remaining video frames, including the video frame 340, the video frame 342, and the video frame 343 may be input to the segmentation network 240 which may remove image content from the video frames to highlight or otherwise emphasize one or more objects of interest within the video frames. The segmentation network 240 may receive the video frames and a description of the object of interest, an image of the object of interest, or the like. In response, the segmentation network 240 outputs a masked video frame 340b, a masked video frame 342b, and a masked video frame 343b.

FIG. 3C illustrates a process 300C of generating descriptions of the content that remains in the masked video frame 340b, the masked video frame 342b, and the masked video frame 343b. In this example, the multi-modal LLM 250 may receive the masked video frame 340b, the masked video frame 342b, and the masked video frame 343b, and output a text-based file 350 with a description of the content in each of the video frames. Here, the multi-modal LLM 250 is hosted by the host platform 330. For example, an image may show a person installing a textile thread onto a threading machine, and the description generated by the multi-modal LLM 250 may recite “a person installing a textile thread on a needle of the machine”, etc. In one embodiment, the LLM is an example of a language machine learning model.

FIG. 3D illustrates a process 300D of the knowledge mapping model 260 generating a knowledge graph 370 based on text content included in a safety specification 360. In this example, the knowledge mapping model 260 is hosted by the host platform 330. Here, the safety specification 360 includes a description of steps 362 that are to be performed by a person when performing the industrial operation with the industrial equipment. The knowledge mapping model 260 may generate the knowledge graph 370 based on the ordering of the steps 362 in the safety specification 360. Here, the knowledge graph 370 includes nodes 372 representing pieces of equipment (devices, etc.), and edges 374 representing relationships between the pieces of equipment.

FIG. 3E illustrates a process 300E of the LLM 270 detecting a potential issue 380 within the video content. In this example, the LLM 270 is hosted by the host platform 330. In one embodiment, the LLM is an example of a language machine learning model. Here, the LLM 270 receives the text-based file 350 with the frame descriptions therein generated by the multi-modal LLM 250 in FIG. 3C, and the knowledge graph 370 generated by the knowledge mapping model 260 in FIG. 3D and generates a description of an issue 380 that is identified by the LLM 270. The description may include an identifier of the mistake or other error, and a way to correct it. For example, potential issue 380 may include a failure to tighten a new gasket to the boiler. In this example, the gasket may be loose. The LLM 270 may output a description of how to address the issue such as “use a wrench to tighten the loose gasket”, etc. The identified issue and/or the suggested remedy may be presented via an output device of the computer, e.g., via a component of the UI device set 123 such as visibly via a display screen, audibly via an audio speaker, in a tactile manner via a feedback pad, etc.

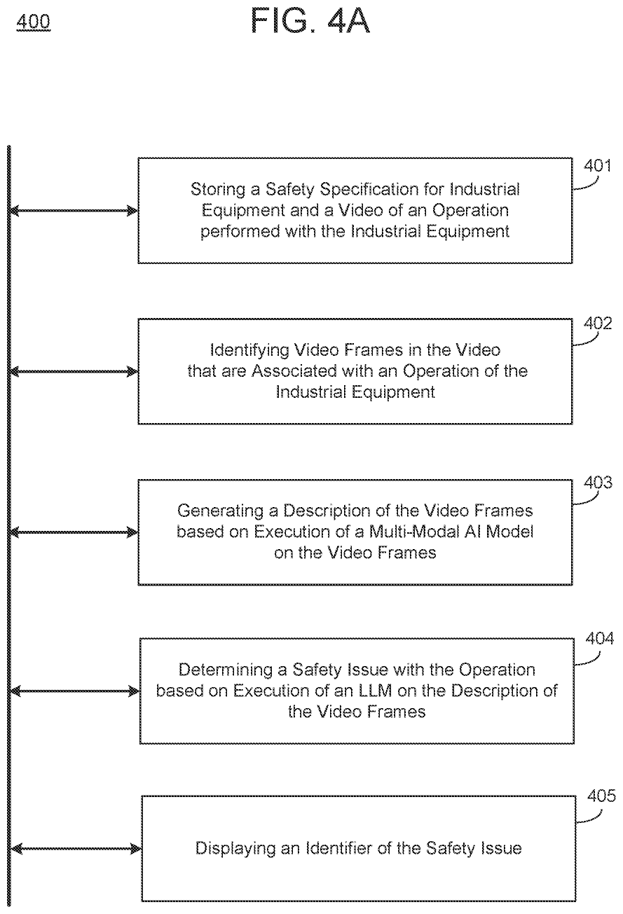

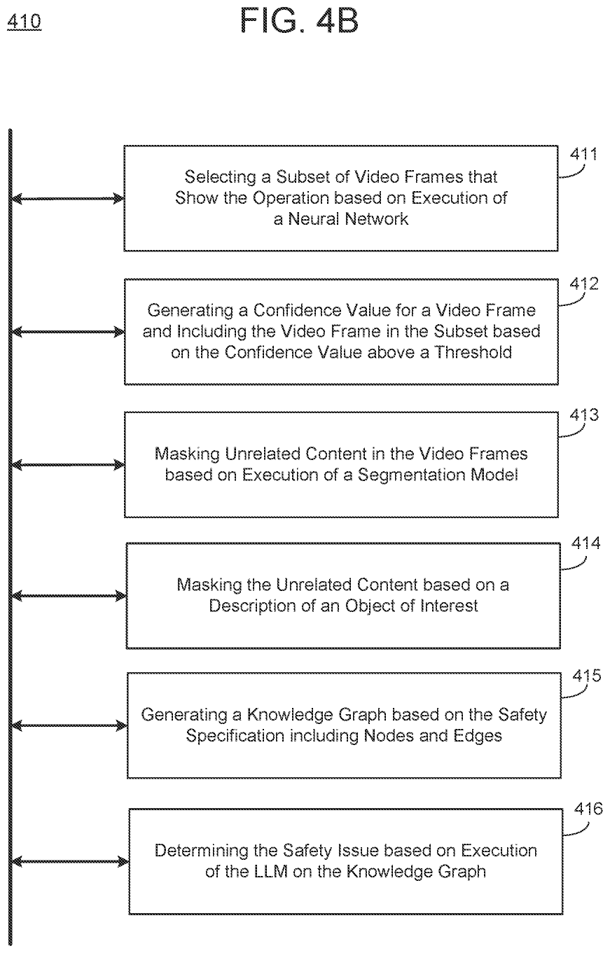

FIG. 4A illustrates a flow diagram 400, according to example embodiments. Referring to FIG. 4A, the method 400 may include storing a safety specification for an industrial equipment and a video of an operation that is performed with the industrial equipment in 401, identifying a plurality of video frames within the video that are associated with the operation that is performed with the industrial equipment in 402, generating a description of the plurality of video frames based on execution of a multi-modal artificial intelligence (AI) model on the plurality of video frames in 403, determining a safety issue with respect to the operation that is performed based on execution of a large language model (LLM) on the description of the plurality of video frames and text content from the safety specification in 404, and displaying an identifier of the safety issue on a display screen associated with the industrial equipment in 405.

FIG. 4B illustrates a flow diagram 410, according to example embodiments. Referring to FIG. 4B, the method 410 may include receiving a description of the operation that is performed, and the identifying comprises selecting a subset of video frames that show the industrial equipment from a set of video frames included in the video based on execution of a neural network on the set of video frames and the description of the operation that is performed in 411, generating a confidence value for a respective video frame among the set of video frames based on the execution of the neural network and including the respective video frame in the subset of video frames when the confidence value is above a predetermined threshold in 412, masking content within the plurality of video frames to remove unrelated content which is unrelated to the industrial equipment based on execution of a segmentation model, prior to the execution of the multi-modal AI model on the plurality of video frames in 413, masking the plurality of video frames based on a description of an object of interest within the video which is input into the segmentation model in 414, generating a knowledge graph based on text content included in the safety specification, wherein the knowledge graph comprises nodes representing pieces of equipment, and edges between the nodes represent operational dependencies between the pieces of equipment in 415, and determining the safety issue with respect to the operation that is performed based on execution of the LLM on the knowledge graph in 416.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
identifying a plurality of video frames within a video of an operation that is performed with industrial equipment;
generating a description of the plurality of video frames based on execution of an artificial intelligence (AI) model on the plurality of video frames;
determining a safety issue with respect to the operation based on execution of a language machine learning model on the description of the plurality of video frames and text from a safety specification for the industrial equipment; and
presenting the safety issue via a computer output device associated with the industrial equipment.

2. The computer-implemented method of claim 1, wherein the method further comprises receiving a description of the operation that is performed, and selecting a subset of video frames from the plurality of video frames that show the operation that is performed from a set of video frames included in the video based on execution of a neural network on the set of video frames and the description of the operation that is performed.

3. The computer-implemented method of claim 2, wherein the method further comprises generating a confidence value for a respective video frame among the set of video frames based on the execution of the neural network and including the respective video frame in the subset of video frames when the confidence value is above a predetermined threshold.

4. The computer-implemented method of claim 1, wherein the method further comprises masking content within the plurality of video frames to remove content which is unrelated to the industrial equipment based on execution of a segmentation model, prior to the execution of the AI model on the plurality of video frames.

5. The computer-implemented method of claim 4, wherein the masking content comprises masking the plurality of video frames based on a description of an object of interest which is input into the segmentation model.

6. The computer-implemented method of claim 1, wherein the method further comprises generating a knowledge graph based on the text from the safety specification, wherein the knowledge graph comprises nodes representing pieces of equipment, and edges between the nodes represent operational dependencies between the pieces of equipment.

7. The computer-implemented method of claim 6, wherein the determining the safety issue with respect to the operation that is performed is based on execution of the language machine learning model on the knowledge graph.

8. A computer system comprising:
a processor set;
a set of one or more computer-readable storage media; and
program instructions, collectively stored in the set of one or more storage media, for causing the processor set to perform computer operations to:
identify a plurality of video frames within a video of an operation that is performed with industrial equipment,
generate a description of the plurality of video frames based on execution of an artificial intelligence (AI) model on the plurality of video frames,
determine a safety issue with respect to the operation based on execution of a language machine learning model on the description of the plurality of video frames and text from a safety specification for the industrial equipment, and
present an identifier of the safety issue via an output device of a computer associated with the industrial equipment.

9. The apparatus of claim 8, wherein the processor is further configured to receive a description of the operation that is performed, and select a subset of video frames from the plurality of video frames that show the operation that is performed from a set of video frames included in the video based on execution of a neural network on the set of video frames and the description of the operation that is performed.

10. The apparatus of claim 9, wherein the processor is further configured to generate a confidence value for a respective video frame among the set of video frames based on the execution of the neural network, and include the respective video frame in the subset of video frames when the confidence value is above a predetermined threshold.

11. The apparatus of claim 8, wherein the processor is further configured to mask content within the plurality of video frames to remove content which is unrelated to the industrial equipment based on execution of a segmentation model, prior to the execution of the AI model, on the plurality of video frames.

12. The apparatus of claim 11, wherein the processor is further configured to mask the plurality of video frames based on a description of an object of interest which is input into the segmentation model.

13. The apparatus of claim 8, wherein the processor is further configured to generate a knowledge graph based on the text from the safety specification, wherein the knowledge graph comprises nodes representing pieces of equipment, and edges between the nodes represent operational dependencies between the pieces of equipment.

14. The apparatus of claim 13, wherein the processor is configured to determine the safety issue with respect to the operation that is performed based on execution of the language machine learning model on the knowledge graph.

15. A computer program product comprising:
a set of one or more computer-readable storage media; and
program instructions, collectively stored in the set of one or more computer-readable storage media, for causing a processor set to perform computer operations comprising:
identifying a plurality of video frames within a video of an operation that is performed with industrial equipment;
generating a description of the plurality of video frames based on execution of an artificial intelligence (AI) model on the plurality of video frames;
determining a safety issue with respect to the operation based on execution of a language machine learning model on the description of the plurality of video frames and text from a safety specification for the industrial equipment; and
displaying an identifier of the safety issue on a display screen associated with the industrial equipment.

16. The computer-readable storage medium of claim 15, wherein the processor is further configured to perform receiving a description of the operation that is performed, and selecting a subset of video frames from the plurality of video frames that show the operation that is performed from a set of video frames included in the video based on execution of a neural network on the set of video frames and the description of the operation that is performed.

17. The computer-readable storage medium of claim 16, wherein the processor is further configured to perform generating a confidence value for a respective video frame among the set of video frames based on the execution of the neural network and including the respective video frame in the subset of video frames when the confidence value is above a predetermined threshold.

18. The computer-readable storage medium of claim 15, wherein the processor is further configured to perform masking content within the plurality of video frames to remove content which is unrelated to the industrial equipment based on execution of a segmentation model, prior to the execution of the AI model on the plurality of video frames.

19. The computer-readable storage medium of claim 18, wherein the masking content comprises masking the plurality of video frames based on a description of an object of interest which is input into the segmentation model.

20. The computer-readable storage medium of claim 15, wherein the processor is further configured to perform generating a knowledge graph based on the text from the safety specification, wherein the knowledge graph comprises nodes representing pieces of equipment, and edges between the nodes represent operational dependencies between the pieces of equipment.
